(19) United States
(12) Patent Application Publication
(10) Pub. No.: US 2012/0012309 A1
(43) Pub. Date: Jan. 19, 2012

(54) Flow Back Recovery System

(75) Inventor: Jerry W. Noles, JR., Newcastle, OK (US)

(73) Assignee: EXPRESS ENERGY SERVICES OPERATING LP, Houston, TX (US)

(21) Appl. No.: 12/953,197

(22) Filed: Nov. 23, 2010

(51) Int. Cl. E21B 43/00; B01D 19/00

(52) U.S. Cl. 166/267; 210/188

(57) ABSTRACT

A system and method for processing flow back from an oil or gas well after a fracturing or other well treatment process includes a first trailer having a high pressure filter, a sand separator, and a choke manifold and a second trailer including a gas separator and holding tanks for water and oil. Each trailer may be equipped with a drip or catch pan to confine any leakage of liquid that may occur.

### BACKGROUND OF INVENTION

1. Field of the Invention

This invention relates to the handling of flow back which occurs during the cleaning or preparation of oil or gas wells for long term production. The flow back material may include a mixture of water, gas, oil, sand, solid rocks or other solids, completion fluid and drilling mud for example. Various components such as filters, sand separators, chokes, liquid gas separators and tanks along with necessary valves, storage tanks and piping are currently used to process the flow back.

2. Description of Related Art

Currently the materials that are recovered during these flow back operations are considered to have little or no commercial value. In most cases the oil, gas, water and sand are all recovered into a common tank wherein the gas is allowed to vaporize to the atmosphere and the sand settles to the bottom of the tank with the oil and water being left to be disposed of or to be manually skimmed and separated during removal. During normal production operations of the well multiple units are used to separate the material from one another. These production separators however are not designed to handle a large amount of contaminates and can become damaged or plugged during this phase of the operation. Therefore the well must be cleaned up and these contaminates removed from the flow prior to the well being placed on long term production. To accomplish this, temporary equipment and facilities that can handle and separate these materials from the commercial commodities are set up. In the past these systems lacked the ability to reclaim or recover the oil and gas mixed with these materials during the flow back. However higher commodity prices and environmental concerns have pushed the oil and gas industry to recover these at much earlier stages during this production. This recovery helps to reduce carbon emissions while selling items that would otherwise be lost to the atmosphere during this stage. As the complexity of this separation process has increased so it has the time and cost associated with the transport and set up of the temporary facilities. Before these facilities can be placed into operation the integrity as well as the functional operation of the equipment must be tested and certified as to their operating capabilities. On high pressure operations these rig up or set up operations can be complicated because the connections must be flanged and bolted together. In addition the higher pressure operations require connections and equipment that is much larger and heavier than standard operations to support the extreme pressure. This set up operation may take days to accomplish with each piece being transported to the well location on separate trucks because of their enormous size and weight. Once on location crews of men work with cranes and winch trucks to off load this equipment and precisely set the equipment the proper distance from one another so they may be connected together and pressure tested. Once all of the equipment has been brought in and assembled a truck screws anchors into the ground and each is load tested, then the piping that connects all of the individual pieces are tied to the anchors. This is done so that in the event a connection or pressure line were to rupture during the operation the restraints would help to contain the release of pressure and energy. In addition spill containment must be put down to prevent oil and other contaminates from soaking into the ground. This entire operation may take several days to accomplish and many accidents, strains and injuries occur during this process. Therefore there is a need to design a system that can eliminate the complexity and reduce the manual labor while improving safety exists.

### BRIEF SUMMARY OF THE INVENTION

The invention utilizes specially designed trailers for select components. These components are permanently attached to the trailer and the piping that connects these components is braced or tied back to the trailer frame rails. The individual components are placed in exact proximity to one another and all lines are permanently installed into the system. In addition this invention provides a permanent drip pan or catch pan around the entire trailer. This drip pan has side rails that are seal welded to prevent the release and spillage of any contaminates should a system failure occur or service be required.

This invention also uses trailers with the equipment positioned on them as to allow for transportation to and from locations without the need for special permits for example for oversized loads.

In one embodiment the flow back is first sent through a high pressure filter or a plug catcher. This assembly is used to filter the larger particles from the flow stream to prevent plugging or fowling of additional equipment within the system. The flow is then diverted through the system to the sand separator where the smaller solid particles such as sand, rocks or other small pieces of solids can be removed from the flow stream. The first two components are only designed to remove the solid materials from the flow back. The flow stream is then routed to a choke manifold that is designed to control or meter the rate that the fluids and gases are flown back from the well. These three components are most commonly used together and are all incorporated into a first trailer assembly along with the control lines and hoses to record pressure and operate the valves and hydraulic chokes. The gas and fluid are then sent to a second trailer where the water, oil and gas can be separated. Once the gas is separated it is then diverted via piping to either a flare line or a sales line. As the gas is removed or vented from the top of the vessel the water and the oil settle in the bottom of the vessel. An internal baffle or a weir further separates the oil from the water. The oil is allowed to collect in one end of the tank while the water collects in the other end. Once the oil and water have been effectively separated they can be transferred via a transfer pump to separate tanks for further processing or disposal.

### BRIEF DESCRIPTION OF THE SEVERAL VIEWS OF THE DRAWING(S)

FIG. 1 is a schematic showing the various components of the flow back treating system.

FIG. 2 is a schematic view of the first trailer according to an embodiment of the invention.

FIG. 3 is a top view of an embodiment of the second trailer of the invention.

FIG. 4 is a side view of the trailer shown in FIG. 4.

FIG. 5 is a view of the gas separator and oil and water tanks.

### DETAILED DESCRIPTION OF THE INVENTION

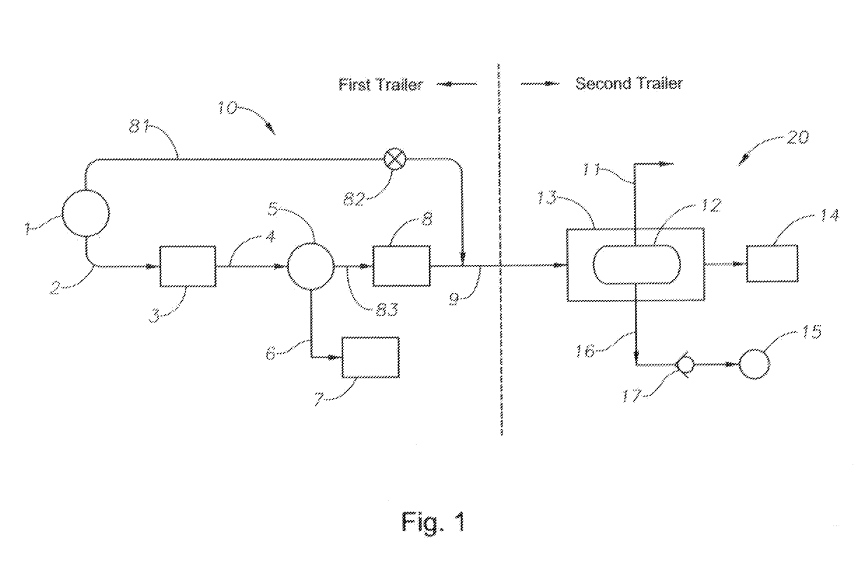

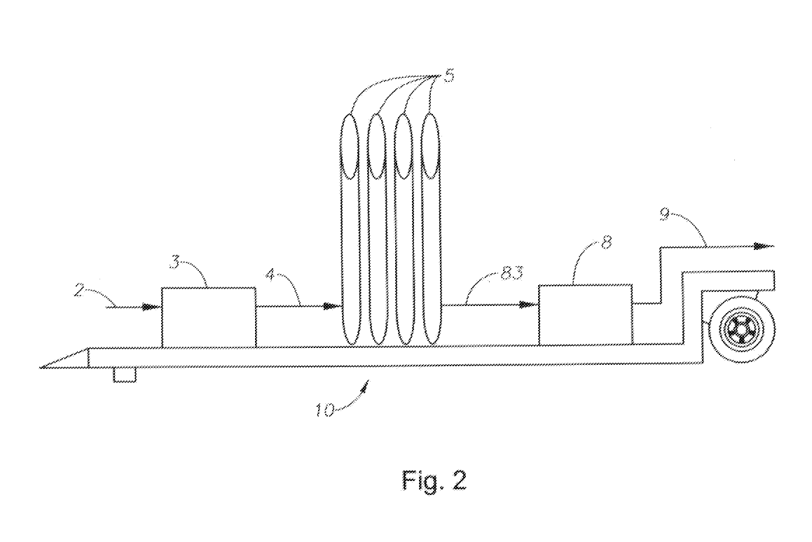

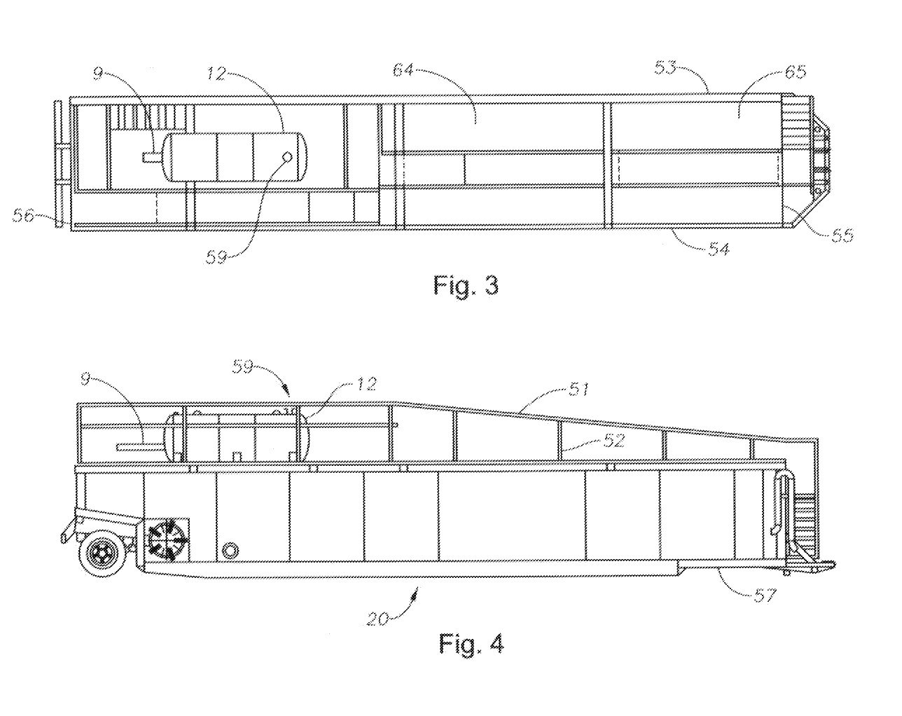

FIG. 1 depicts an embodiment overall design of the system. Flow back from a well head 1 is directed via conduit 2 to a first trailer 10. Trailer 10 includes a high pressure filter 3 for filtering out relatively large solid particles such as rocks or pieces of equipment that have been broken up during the well completion process. The filter 3 may be formed with high strength metal screens. A second conduit 4 extends to sand separator 5 which is preferably of the type disclosed in copending application Ser. No. 12/766,079 field on Apr. 23, 2010, the contents of which is hereby expressly incorporated herein. The sand separator may include one separator unit or a plurality of units as schematically shown at 5 in FIG. 2. A conduit 6 connected to sand separator 5 carries separated sand to a sand tank 7 remote from trailer 10. Another conduit 83 is connected between sand separator 5 and choke manifold 8. A conventional choke manifold 8 is located in conduit 9 to control the pressure in the conduit. A bypass line 81 with a suitable valve 82 may be provided between the well head and conduit 9.

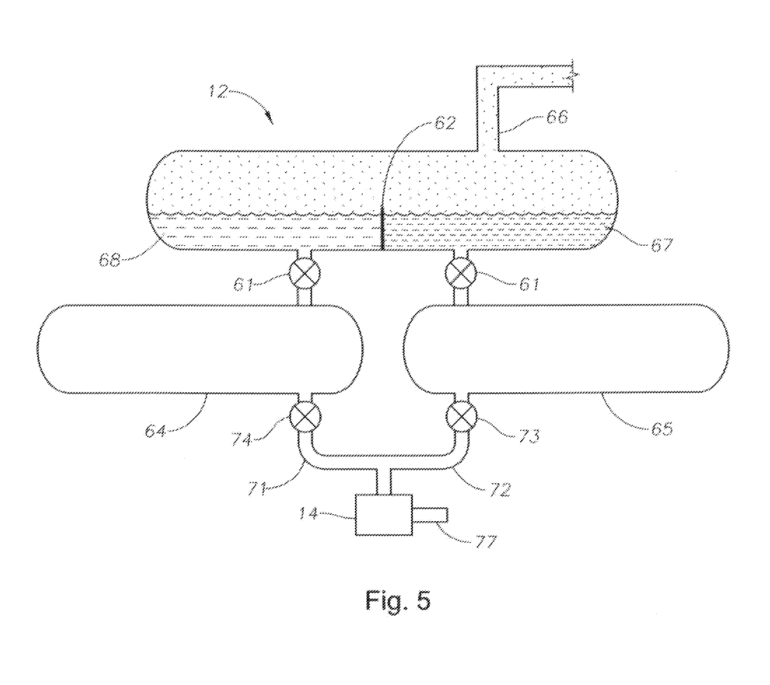

The remaining flow back which may contain gas, oil, and water is then directed via conduit 9 to a second trailer 20 to a gas separator 12. Gas separator 12 also separates the water and oil by any suitable known device such as an internal baffle 62 or weir shown in FIG. 5. The lighter weight oil may be discharged over baffle or weir 62 into an oil confining section 67 located in the gas separator.

The water and oil levels are controlled by the wise of conventional fluid dumps that open valves 61 and allow the liquids to be discharged from the bottom of the liquid/gas separator into holding tanks 64, 65 located within the trailer for the water and oil. When gravity dumps and fluid floats are used it can eliminate the need to maintain constant gas pressure to operate the dump controls. This allows the fluid and gas to be efficiently separated with varying pressures on the vessel without effecting the operation of the oil and water separation. The water and oil may be separately transferred via conduits 71 and 72 and valves 73, 74 and a transfer pump 14 to a remote location. Gas from the gas separator is diverted via outlet conduit 66 either to the gas sales line 11 or a flare 13 through a check valve 17. Once the gas has reached a commercial value and the pressure is sufficient to overcome the sales line pressure, it can be diverted to sales line 11.

Both trailers include a bottom wall 57, two side walls 53 and 54, and a front 55 and rear 56 wall that are integrally formed together so as to form a liquid tight container or drip pan that will confine any leaks from the various components mounted within the perimeter of the bottom, side, and front and rear walls.

The current invention reduces the time required for set up while eliminating most of the Health Safety and Environmental concerns associated with this operation. The current invention takes a systematic approach to this operation and uses a specially designed trailer system to contain individual components for the operation. Recent advancements in component design have helped to reduce the weight and size of many of the components. This invention utilizes specially designed trailers for select components. These components are permanently attached to the trailer and the piping that connects these components is braced or tied back to the trailer frame rails 51 and 52. The pipes are then placed in clamps that are attached to these braces. This allows not only the weight of the assembly to be supported but also provides a pre-engineered restraint to contain the release of energy should a failure occur during operations resulting in the release of energy. In addition the individual components are placed in exact proximity to one another and all lines are permanently installed into the system. The trailers design also allows the skids of the trailer to be placed directly on the ground or in close proximity thereto so access and service to the components during the operations do not provide additional hazards associated with working on an elevated trailer. This invention allows the base of the components to be at a height no greater than the frame rail of the trailer itself which is approximately 10″ to 14″ from ground level. In addition this invention provides a permanent drip pan or catch pan around the entire trailer. This drip pan having side walls and being seal welded prevents the release and spillage of any contaminates should a system failure occur or service be required. This secondary containment eliminates the need for temporary spillage barriers during the operation. In addition by having the components preset prior to the operation all of the components and piping can be tested prior to being transported to the set up location. This allows the testing to be performed in a controlled environment with limited exposure to personnel. This invention substantially reduces the potential for injury during this phase of the operation. This invention also eliminates the need for manual lifting of the piping and reduces the number of personnel to assemble as well as reducing simultaneous operations. This invention further reduces the need for cranes and winch truck usage during the set up and installation of the equipment. This invention uses a trailer with the equipment positioned as to allow transportation to and from location without the need for special permitting. In one embodiment the trailers uses hydraulic jacks to raise and lower the front of the trailer to allow the trucks that transport the assembly to and from location to couple to the trailer without the need of additional lifting equipment such as winches. This configuration can also eliminate the need to vent gas to the atmosphere during flow back operations and allows the commercial value of the gas to be determined much earlier in the process. This invention can substantially reduce the carbon emissions associated with flow back operations. This invention can not only improve the safety of the operation but can also substantially reduce the time required making the time spent on location more efficient saving time and money while reducing labor needs.

Although the present invention has been described with respect to specific details, it is not intended that such details should be regarded as limitations on the scope of the invention, except to the extent that they are included in the accompanying claims.

It is understood that modifications to the invention may be made as might occur to one skilled in the field of the invention within the scope of the appended claims. All embodiments contemplated hereunder which achieve the objects of the invention have not been shown in complete detail. Other embodiments may be developed without departing from the spirit of the invention or from the scope of the appended claims. Although the present invention has been described with respect to specific details, it is not intended that such details should be regarded as limitations on the scope of the invention, except to the extent that they are included in the accompanying claims.

I claim:

1. A flow back processing system comprising:
a first trailer having a liquid tight containment compartment;
a high pressure filter having an inlet mounted on the first trailer;
a sand separator connected to the high pressure filter via a conduit and also mounted on the first trailer;
a choke manifold connected to the sand separator via a second conduit and having an outlet, the choke manifold mounted on the first trailer;
a second trailer having a liquid tight containment compartment;
a gas separator having an inlet for a gas and liquid mixture mounted on the second trailer;
a dump valve within the gas separator for maintaining a constant level of liquid within the gas separator;
a first storage tank mounted on the second trailer connected to the gas separator via the dump valve for storing separated liquid; and
a gas outlet in the gas separator for discharging gas from the gas separator.

2. The system according to claim 1 further including a gas conduit extending from the gas outlet to a gas sales line and a second gas conduit extending to a gas flare.

3. A method of processing flow back from an oil or gas well comprising:
providing the apparatus of claim 1, connecting the inlet of the high pressure filter to a well head after fracturing or completing another well completion process;
connecting the output of the choke manifold to the input of the gas separator; and
allowing the flow back material to flow from the well head to the high pressure filter.

4. The system of claim 2 further including a weir or baffle within the gas separator, a container for collecting oil as it flows over the weir or baffle and an oil storage tank located within the containment compartment for storing the separated oil.

5. The method of claim 3 further including directing the gas from the gas separator to a gas sales line.

6. The method of claim 3 further including directing the gas from the gas separator to a flare.

7. A flow back processing system comprising:
a trailer having a liquid tight containment compartment;
a gas separator having an inlet for a gas and liquid mixture mounted on the trailer;
a dump valve within the gas separator for maintaining a constant level of liquid within the gas separator; and
a gas outlet in the gas separator for removing gas from the gas separator.

8. A flow back processing system as claimed in claim 7 wherein the gas separator includes an internal baffle forming two liquid compartments, and first and second dump valves, one for each compartment.

9. A flow back processing system as claimed in claim 7 further including a gas conduit extending from the gas outlet for connection to a gas sales lines or a gas flare or both.

10. A flow back processing system as claimed in claim 7 including a first storage tank mounted on the trailer and connected to the gas separator via the dump valve for storing separated liquid.

11. A flow back processing system as claimed in claim 8 further including a first storage tank connected to the first dump valve.

12. A flow back processing system as claimed in claim 11 further including a second storage tank connected to the second dump valve.

13. A flow back processing system comprising:
a trailer having a liquid tight containment compartment;
a high pressure filter having an inlet mounted on the trailer;
a sand separator connected to the high pressure filter via a conduit and also mounted on the trailer; and
a choke manifold connected to the sand separator via a second conduit and having an outlet, the choke manifold mounted on the trailer.
